(19) United States
(12) Patent Application Publication
(10) Pub. No.: US 2006/0090078 A1
(43) Pub. Date: Apr. 27, 2006

(54) Initiation of an application

(76) Inventors: Michael M. Blythe, Albany, OR (US); Donald L. Eckhart, Corvallis, OR (US); Dennis Sandow, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/969,837

(22) Filed: Oct. 21, 2004

(51) Int. Cl. H04L 9/00

(52) U.S. Cl. 713/185

(57) ABSTRACT

A token having a symbol can cause initiation of an application.

### BACKGROUND

Interactive electronic display surfaces allow users to exploit the display surface as a mechanism both for viewing content, such as computer graphics, video, etc., as well as inputting information into the system. Many interactive display surfaces are configured to receive input data through a wire coupled communication device such as a controller, a keyboard, a mouse, and the like.

### BRIEF DESCRIPTION OF THE DRAWINGS

The accompanying drawings illustrate various exemplary embodiments of the present system and method and are a part of the specification. The illustrated embodiments are merely examples of the present system and method and do not limit the scope thereof.

FIG. 1 is a perspective view of an interactive display system, according to one exemplary embodiment.

FIG. 2 is an exploded perspective view of the interactive display system of FIG. 1, according to one exemplary embodiment.

FIG. 3 is a close-up perspective view of a portion of a digital light processor used in the display system of FIG. 1, according to one exemplary embodiment.

FIG. 4 is a simple block diagram illustrating the components of a token including one or more symbols, according to one exemplary embodiment.

FIG. 5 is a flow chart illustrating a method for initiating and manipulating an application on an interactive display system, according to one exemplary embodiment.

FIG. 6 is detailed block diagram illustrating the components of a token including one or more symbols, according to one alternative exemplary embodiment.

FIG. 7 is a logical schematic diagram illustrating the communication paths of the interactive display system, according to one exemplary embodiment.

Throughout the drawings, identical reference numbers designate similar, but possibly not identical, elements.

### DETAILED DESCRIPTION

The present exemplary system and method use familiar tokens or physical objects as tools to start and manipulate applications, such as in some embodiments software applications that may be provided by a third party. More specifically, through the use of one or more symbols or other communication mechanisms, software applications present on an interactive display system are started and/or manipulated. Further, a system and a method are disclosed that facilitate optical communication between a system controller or processor and a token or physical object that includes one or more symbols, utilizing the pixels or display surface of an embodiment of a display system, such as interactive display system (10) as a communication medium. The optical communication, along with a feedback methodology, enables the interactive display system and the token having one or more symbols to start and/or manipulate applications. The display surface may be a glass surface configured to display an optical light image generated by an image projection device, such as a digital light projector (DLP), a liquid crystal display (LCD), or any other projection device, in response to digital signals from the controller. The token including one or more symbols may take various forms such as, but not limited to, pointing devices, cellular telephones, game pieces, measuring tools, MP3 players, digital cameras, computer mice, traditional paper manipulation tools, or any other physical object that includes a communication language disposed thereon.

The system detects the presence of a token including one or more symbols on the surface via an optical sensor. Once detected, the system identifies and interprets the one or more symbols or other communication language from the token and automatically starts and manipulates an application associated with the token, as identified by the one or more symbols. Simultaneous with the optical detection, the image projection device may generate a continuous still or moving video or graphic, such as a movie video, a video game, computer graphics, Internet Web pages, etc. on the display surface, in response to the related application.

In the following description, for purposes of explanation, numerous specific details are set forth in order to provide a thorough understanding of the present system and method for representing a specific application toolset with a viewable physical device. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification may possibly not be referring to the same embodiment.

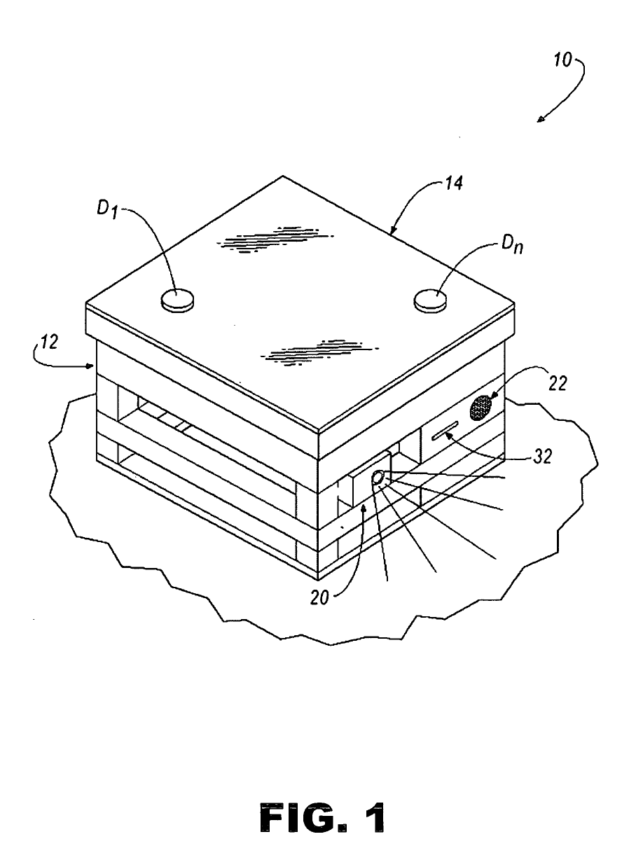

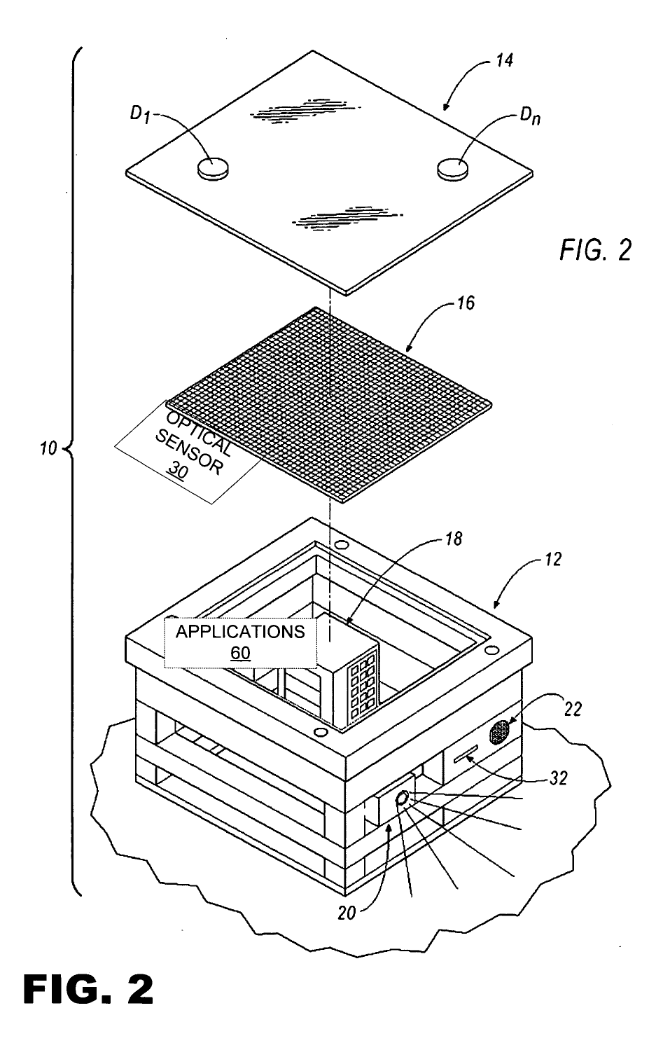

Referring now to FIGS. 1 and 2, interactive display system (10) is shown according to one exemplary embodiment. According to the exemplary embodiment shown, the interactive display system (10) is shown as embodied in a “table” (12), with the table surface functioning as the display surface (14). According to the exemplary configuration illustrated in FIGS. 1 and 2, multiple users (each having his/her own token (D₁-Dₙ) including one or more symbols) can view and access the display surface (14) by positioning themselves around the table (12). While the present exemplary system and method are described in the context of an interactive display system (10) embodied in a table (12), the physical embodiment of the display system can take any number of forms other than that of a “table.”

Continuing with reference to FIGS. 1 and 2, the exemplary interactive display system (10) includes an embodiment of a display device having a display surface (14) and a digital light processor (DLP) (16). Interactive display system 10 further includes at least one optical sensor (30), and a controller (18) having access to one or more applications (60). According to one exemplary embodiment, the controller (18) is configured to generate electrical image signals indicative of viewable images, such as computer graphics, movie video, video games, Internet Web pages, etc., which are provided for generation to the DLP (16). The controller (18) can take several forms, such as a personal computer, microprocessor, or other electronic devices capable of providing image signals to a DLP. The DLP (16), in response to the electrical signals, generates digital optical (viewable) images on the display surface (14). The controller (18) may receive data and other information to generate the image signals from various sources, such as hard drives, CD or DVD ROMs (32), computer servers, local and/or wide area networks, hosted applications (60), and the Internet, for example. Additionally, the controller (18) may receive data and other information received by the at least one optical sensor (30). The optical sensor (30) may include, but is in no way limited to, a charge coupled device (CCD), a complementary metal oxide semiconductor (CMOS) laser sensor, or any other optical sensor configured to detect the presence of a token (D₁) including one or more symbols (42) on the display surface (14). The controller (18) may also provide additional output in the form of projected images from an auxiliary projector (20) and sound from a speaker (22).

As shown in FIGS. 1 and 2, the interactive display system (10) can include a variety of additional components, such as a projector (20), configured to simultaneously project the content of the display surface (14) onto a wall-mounted screen, for example. The interactive display system (10) may also include one or more speakers (22) for producing audible sounds that accompany the visual content on the display surface (14). Further, the interactive display system (10) may include one or more devices for storing and retrieving data, such as a CD or DVD ROM drive, disk drives, USB flash memory ports, etc.

While the interactive display system (10) is described herein in the context of a display device including a DLP (16), the present systems and methods are in no way limited to initiating and manipulating a specific software application (60) using a token including one or more symbols through a display surface (14) and a DLP display device (16). Rather, any number of display devices having an optical sensor configured to detect an object on a display surface may be used to automatically initiate applications according to the present exemplary embodiment including, but in no way limited to, a liquid crystal display (LCD), a plasma display, or a flat panel display. Further, while the above-mentioned display surface (14) is configured to display viewable images in addition to data being transferred via an optical sensor (60), the present systems and methods may be incorporated by a back-view display device that is solely configured to initiate and manipulate software applications with a token (D₁-Dₙ) that includes one or more symbols thereon without regard to the optical transfer of data.

According to the exemplary embodiment illustrated in FIGS. 1 and 2, the DLP (16) may assume a variety of forms. In general, the DLP (16) generates a viewable digital image on the display surface (14) by projecting a plurality of pixels of light onto the display surface. Each viewable image may be made up of millions of pixels. Each pixel is individually controlled and addressable by the DLP (16) to have a certain color (or grey-scale). The combination of many light pixels of different colors (or grey-scales) on the display surface (14) generates a viewable image or “frame.” Continuous video and graphics may be generated by sequentially combining frames together, as in a motion picture.

One embodiment of a DLP (16) includes a digital micro-mirror device (DMD) configured to vary the projection of light pixels onto the display surface (14). Other embodiments could include, but are in no way limited to, diffractive light devices (DLD), liquid crystal on silicon devices (LCOS), plasma displays, and liquid crystal displays. Additionally, other spatial light modulator and display technologies could be substituted for the DLP (16) without varying from the scope of the present system and method.

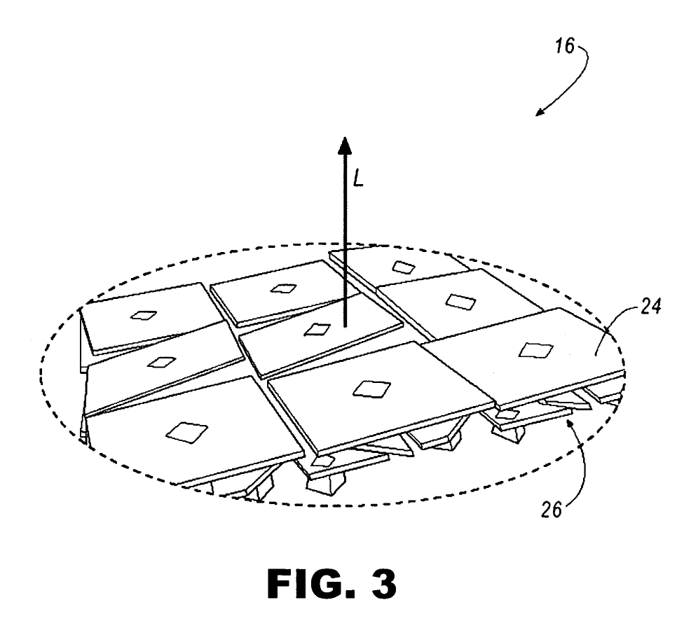

FIG. 3 is a close-up view of a portion of an exemplary DMD, according to one exemplary embodiment. As shown in FIG. 3, the DMD includes an array of micro-mirrors (24) individually mounted on hinges (26). Each micro-mirror (24) corresponds to one pixel in an image projected on the display surface (14). The controller (18; FIG. 2) provides light modulation signals indicative of a desired viewable image or optical data stream to the DLP (16). In response to the received signals, the DLP (16) causes each micro-mirror (24) of the DMD to modulate light (L) to generate an all-digital image onto the display surface (14). Specifically, the DLP (16) causes each micro-mirror (24) to repeatedly tilt toward or away from a light source (not shown) in response to the image signals from the controller (18), effectively turning the particular pixel associated with the micro-mirror “on” and “off”, which normally occurs thousands of times per second. When a micro-mirror (24) is switched on more frequently than off, a light gray pixel is projected onto the display surface (14). Conversely, when a micro-mirror (24) is switched off more frequently than on, a darker gray pixel is projected. A color wheel (not shown) may also be used to create a color image. The individually light-modulated pixels may be configured to form a viewable image or frame on the display surface (14).

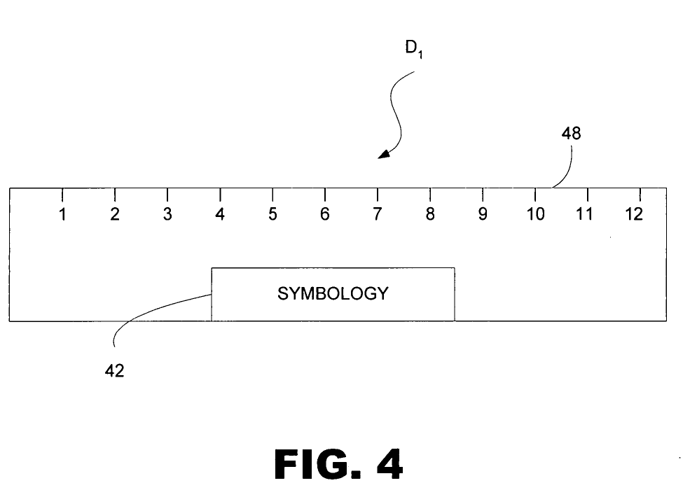

Returning again to FIGS. 1 and 2, the interactive display system (10) further includes one or more tokens having a communication language or one or more symbols formed thereon, shown in FIGS. 1 and 2 as elements (D₁) and (D_{N}). The token (D₁, D_{N}) having one or more symbols associated therewith can take a variety of physical forms, such as pointing devices (computer mouse, white board pen, etc.), gaming pieces, multimedia devices, physical manipulation tools, and the like. FIG. 4 further illustrates the components of the token (D₁-D_{N}) including one or more symbols. As shown in FIG. 4, the exemplary token (D₁) having one or more symbols formed thereon has an outer housing (48) resembling a ruler, and includes a communication language or one or more symbols (42) formed thereon. As mentioned previously, the outer housing (48) of the token (D₁) having one or more symbols formed thereon may assume any number of shapes and sizes including, but in no way limited to, pointing devices (computer mouse, white board pen, etc.), gaming pieces, multimedia devices, physical manipulation tools, and the like. According to one exemplary embodiment, the outer housing (48) of the token (D₁) assumes a shape associated with a function to be initiated thereby. For example, the exemplary token (D₁) illustrated in FIG. 4 is illustrated as a ruler. According to one exemplary embodiment, the ruler may be configured to initiate a paint application and facilitate the use of a line-drawing tool set or sub application. Further details of the one or more symbols (42) associated with the token (D₁) will be given below.

As shown in FIG. 4, the token having one or more symbols formed thereon (D₁) includes a processor readable communication language or one or more symbols (42) configured to encode numbers, letters, special character control characters, or a combination thereof, on at least one surface of the token. The one or more symbols (42) may be any processor recognizable character(s) that is configured to identify and initiate an application (60) when detected by a processor.

According to one exemplary embodiment, the one or more symbols (42) used to initiate an application (60) is a 2 dimensional DataMatrix. A DataMatrix is a two or three-dimensional barcode which can store from 1 to approximately 2,000 characters. The symbol is generally quadratic in shape and can range from 0.001 inch per side to over 13.5 inches per side. As an example of density, 500 numeric only characters can be encoded in a 1-inch square using a 24-pin dot matrix printer. These characters, when detected and analyzed by a processor, may then be used to initiate an application (60) resident on an interactive display system.

Alternatively, the one or more symbols (42) formed on the token (D₁) may be any type of discrete or continuous bar code that may represent processor recognizable characters including, but in no way limited to, code 3 of 9 barcodes, universal product code (UPC)-A, UPC-E, UPC 5 or 2 digit adder, integer 2 of 5, Code 128 (A, B & C), European article numbering (EAN) 8, EAN-13, health industry bar code (HIBC) (Modulus 10), Coderbar (Codabar), Plessey, Case Code, Code 93, Telepen, Zip, facing identification marking (FIM), portable document format (PDF)-417, LogmarsPostnet, united parcel service (UPS) Maxicode, and the like. Further, the one or more symbols (42) formed on the token may be an array of light emitting diodes (LED).

Returning again to FIG. 2, the optical sensor (30) configured to detect the token (D₁) and its associated one or more symbols (42) may vary based on the one or more symbols (42) incorporated by the token (D₁). As mentioned previously, the optical sensor (30) may be a charge coupled device (CCD) or a complementary metal oxide semiconductor (CMOS) laser sensor. Additionally, the optical sensor (30) may be a one-dimensional (linear) scanner, a two or three-dimensional scanner, a three-dimensional scanner, or any other optical sensor configured to detect the presence of a token including one or more symbols on the display surface (14). Additionally, the optical sensor may be equipped with an auto-discrimination feature configured to automatically recognize and read different symbols, allowing tokens (D₁) having different symbols (42) to be sensed and decoded by a single optical sensor (30).

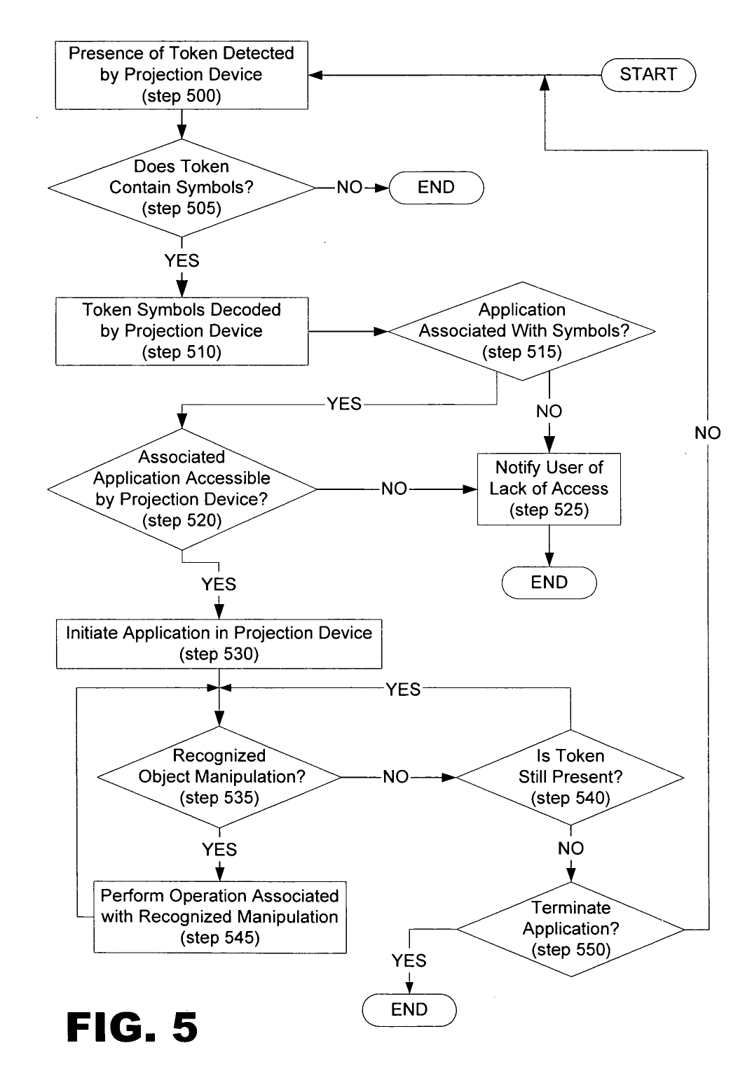

FIG. 5 illustrates an exemplary method for initiating and manipulating an application on an interactive display device (10), according to one exemplary embodiment. As illustrated in FIG. 5, the exemplary method begins by first detecting the presence of a device or object, such as a token, on the viewing surface of the interactive display device (10) (step 500). Detecting the presence of a token may be performed by the optical sensor (30) performing an image subtraction method, a motion detection method, or any other token presence detecting method.

Once a token is detected (step 500), the interactive display device (10) determines whether the token contains one or more symbols thereon (step 505). According to one exemplary embodiment, the optical sensor (30) in the form of a CCD or CMOS laser scanning system scans the surface of the identified token searching for a 2 dimensional DataMatrix or other symbols. If there are no symbols detected on the token (NO, step 505), the interactive display device (10) terminates its analysis of the token. If, however, symbols are detected on the token (YES, step 505), the symbols are decoded by the interactive display device (10) (step 510). Accordingly, the interactive display device (10) reads the symbols present on the token. According to one exemplary embodiment, the symbols will be decoded to reveal a code which is then processed by the interactive display device (10). The interactive display device (10) compares the received code against a database of codes to discover the applications related to the symbols (step 515), as well as functionality and operational characteristics of each tool as it relates to a number of identified applications.

If an associated application is not identified, the user is notified to that effect (step 525) through the viewing surface, and the interactive display device (10) ends its analysis. If, however, there is an application identified by the symbols (YES, step 515), the interactive display device (10) compares the identified application associated with the symbols (42) to a number of applications accessible by the interactive display device to locate a matching application (step 520). If the identified application is not accessible by the interactive display device (NO, step 520), again the user is notified to that effect (step 525), and the interactive display device (10) ends its analysis. However, if the identified application is accessible by the interactive display device (10) (YES, step 520), the application is initiated by the interactive display device (10) (step 530). Initiation of the identified application may include auto-populating the display surface (14) with a graphical user interface (GUI) associated with the application (60).

Once the identified application is initiated, the interactive display device (10), via the optical sensor, determines if a recognized token manipulation is performed by the identified token (step 535). According to one exemplary embodiment, a number of token motions, positions, and/or configurations correspond with sub applications that may be performed within the identified application itself. In other words, tools that are stored on or within the identified token could be used to manipulate the application. If a recognized token manipulation is detected (YES, step 535), the manipulation is linked with an operation or sub application and that operation is performed by the interactive display device (10) (step 545) and the display surface (14) is again monitored for recognized token manipulations (step 535).

If, however, no token manipulation is recognized (NO, step 535), the interactive display device (10) determines whether the token is still present on the viewing surface (step 540). According to one exemplary embodiment, the optical sensor (30) may perform an image subtraction method or other surface sensing operation to detect the presence of the previously identified token. If the token is still present on the display surface (YES, step 540), the interactive display device will continue to monitor the display surface (14) for a recognized token manipulation (step 535).

If, however, it is determined that the token is not present on the display surface (NO, step 540), the interactive display device (10) will prompt the user for an input indicating a desire to terminate the application (step 550). The user may be prompted in any number of ways including, but in no way limited to, a visual request asking for a confirmation of application termination. If the user indicates a desire not to terminate the application (NO, step 550), the interactive display device (10) monitors for the presence of another token associated with the application being placed on the display surface (step 500). If, on the other hand, the user indicates a desire to terminate the application (YES, step 550), the application is terminated.

While the above-mentioned exemplary method is described in the context of initiating an application (60) on the interactive display device (10) in response to a sensed token symbol (42), the symbol may also initiate firmware applications present in the interactive display device. Additionally, the method illustrated above may cause the sensed token symbol (42) to initiate or modify applications operating in a component communicatively coupled to the interactive display device (10).

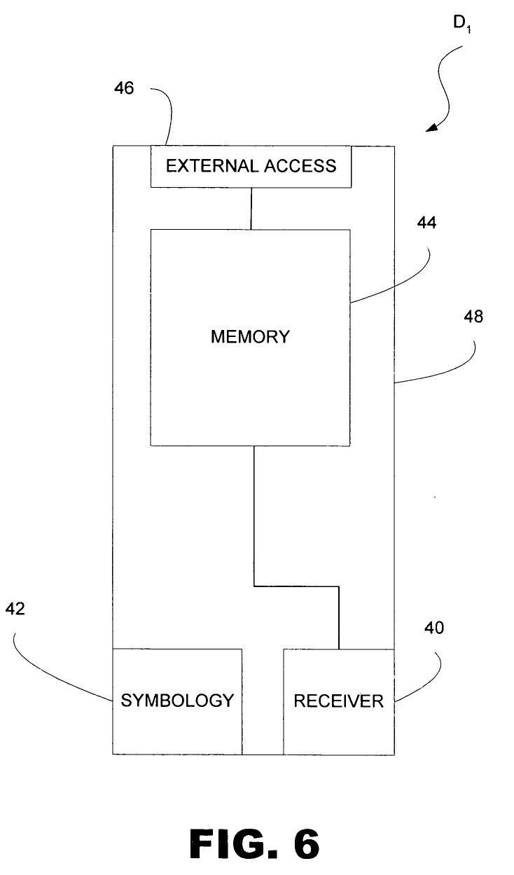

In an alternative embodiment, the token (D₁) including one or more symbols may be configured to optically communicate with the interactive display system (10) through the display surface (14) as illustrated in FIG. 6. As shown, the alternative token (D₁) including one or more symbols includes an outer housing (48) that may assume any number of physical forms and a communication language or symbols (42) formed thereon, similar to the exemplary embodiment illustrated in FIG. 4. Additionally, the alternative token (D₁) including one or more symbols includes optical receiver (40), a memory (44) or other data storage device, and an external access device (46). According to one exemplary embodiment of the alternative token (D₁) including one or more symbols, the optical receiver (40) is configured to receive optical signals from the DLP (16) through the display surface (14). For example, the optical receiver (40) may be a photo receptor such as a photocell, a photo diode, a charge coupled device (CCD), or any other optical signal receiving device embedded in the bottom of the token (D₁) including one or more symbols.

Further, FIG. 6 illustrates the memory component (44) communicatively coupled to the receiver (40). According to one exemplary embodiment, the memory component (44) may be any device, or combination of devices, configured to selectively receive, format, and store received data. Accordingly, the memory component (44) may include, but is in no way limited to, a memory access ASIC or a processor, a read only memory (ROM), a random access memory (RAM), a flash memory, a virtual memory, and the like.

The external access component (46) of the token (D₁) including one or more symbols is configured to allow a user to access data saved in the memory component (44). Accordingly, any number of external access components (46) may be included in the token (D₁) bearing one or more symbols including, but in no way limited to, an earphone jack, a speaker jack, an infrared transmitter, a radio frequency transmitter, a speaker, a motion actuator, a light source, a keystone jack, a universal serial bus (USB) port, a serial port, and/or a wireless transmitter. According to one exemplary embodiment, an external access component (46) in the form of a wireless transmitter is configured to transmit data to an external receiving device, such as the controller (18; FIG. 2). This allows the tokens (D₁-D_{N}) including one or more symbols to communicate their respective positions and/or subset application commands to the controller (18; FIG. 2) or with other tokens including symbols through the display surface (14), as will be further developed below.

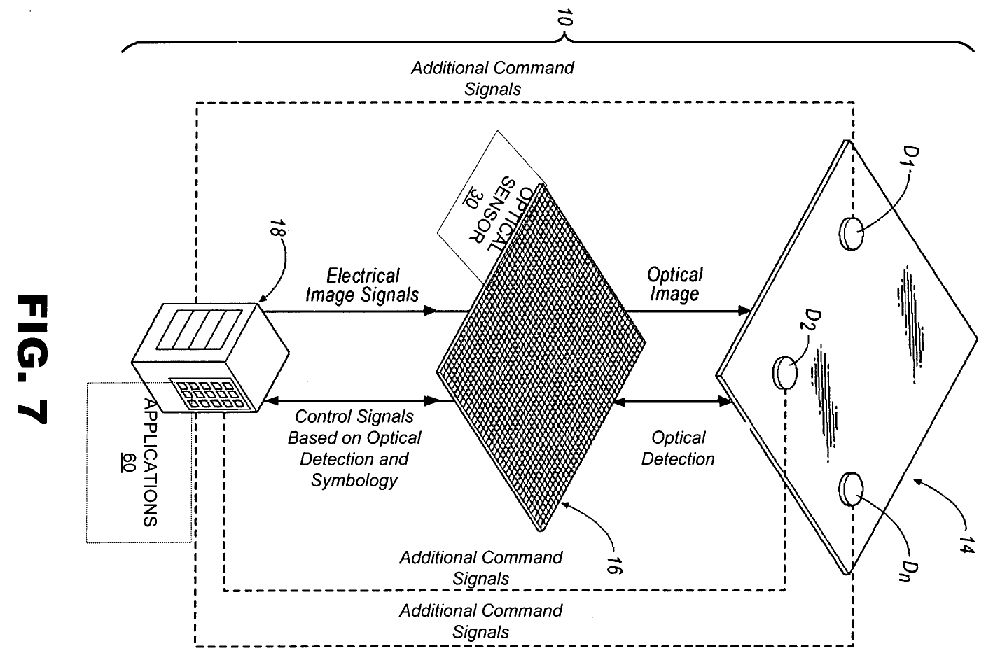

As shown in FIG. 7, the interactive display system (10) facilitates two-way communication between the controller (18) and the tokens (D₁, D₂, D_{N}) including one or more symbols by first detecting the tokens (D₁, D₂, D_{N}) and initiating applications (60) based on the one or more symbols disposed on the tokens. As shown, the symbols are detected and read via optical detection. Additionally, as illustrated, additional command signals may be transmitted to the controller (18) via external access components (46; FIG. 6) such as transmitters. Further, each token (D₁, D₂, D_{N}) including one or more symbols placed in contact with the display surface (14) may receive optical data signals from the controller (18) in the form of modulated optical signals (optical positioning signals) via the DLP (16), which is controlled by electrical positioning signals and electrical image signals from the controller (18). The optical signal transmitted by the DMD may be in the form of a series of optical pulses that are coded according to a variety of encoding techniques.

Two-way communication between the controller (18) and each token (D₁, D₂, D_{N}) including one or more symbols allows the interactive display system (10) to accommodate simultaneous input from and output to multiple tokens including one or more symbols. Two-way communication between the tokens (D₁, D₂, D_{N}) including one or more symbols and the controller (18) allows the system to use a feed-back mechanism to establish a unique “handshake” between each token including one or more symbols and the controller. The unique “handshake” can be accomplished in various ways.

In conclusion, embodiments of the present system and method for representing a specific tool set with a viewable device or objects uses, in one embodiment, familiar tokens as tools to start and manipulate applications accessible by a back-view horizontal display unit. More specifically, through the use of one or more symbols or other communication mechanisms present on the token, software applications present on an interactive display system are automatically started and/or manipulated, thereby enhancing the user experience.

The preceding description has been presented only to illustrate and describe exemplary embodiments of the system and method. It is not intended to be exhaustive or to limit the system and method to any precise form disclosed. Many modifications and variations are possible in light of the above teaching. It is intended that the scope of the system and method be defined by the following claims. Where the claims recite “a” or “a first” element of the equivalent thereof, such claims should be understood to include incorporation of one or more such elements, neither having to include nor excluding two or more such elements.

What is claimed is:

1. A system comprising:
a token having a symbol configured to cause initiation of an application on a computing device.

2. The system of claim 1, wherein said token comprises a housing, said housing assuming a physical shape associated with said application.

3. The system of claim 1, wherein said token comprises one or more symbols.

4. The system of claim 1, wherein said symbol comprises a 2 or 3-dimensional data matrix.

5. The system of claim 1, wherein said symbol comprises one of a barcode or an array of light emitting diodes (LED).

6. The system of claim 1, wherein said symbol is further configured to initiate a toolset associated with said application.

7. The system of claim 1, wherein said initiation of an application on a computing device occurs in response to an analysis of the symbol by the computing device

8. The system of claim 1, wherein said symbol is disposed on a surface of said token.

9. The system of claim 8, wherein said symbol is disposed on a bottom surface of said token; and
said computing device comprises a back-view display device including an optical sensor configured to detect a presence of said token.

10. The system of claim 1, wherein said token further comprises:
an optical receiver configured to receive optical data from said computing device;
a data storage device; and
an external access component.

11. The system of claim 10, wherein said external access component comprises one of a earphone jack, a speaker jack, an infrared transmitter, a radio frequency transmitter, a speaker, a motion actuator, a light source, a keystone jack, a universal serial bus (USB) port, or a serial port.

12. The system of claim 10, wherein said external access component comprises a transmitter configured to facilitate wireless communication between said token and said computing device.

13. A display system comprising:
a display device;
an optical sensor; and
a controller communicatively coupled to said optical sensor and said display device, wherein said controller includes a configuration to initiate an application based on sensing a symbol on a token.

14. The display device of claim 13, wherein said controller is further configured to select on application from a plurality of applications based on said symbology.

15. The display device of claim 13, wherein the display device includes a display surface and a projection device configured to project a plurality of pixels onto the display surface.

16. The display device of claim 15, wherein said projection device comprises a digital light processor.

17. The display device of claim 15, wherein said projection device is configured to project a graphical user interface onto said display surface in response to an initiation of said application.

18. The display device of claim 13, wherein said controller is further configured to manipulate said application in response to a sensed movement of said token.

19. The display device of claim 13, wherein said controller is further configured to initiate a toolset associated with said application in response to a sensing of said symbol.

20. The display device of claim 13, wherein said display device comprises one of a liquid crystal display (LCD), a plasma screen, or a flat panel screen.

21. The display device of claim 13, wherein said symbol comprises a two or three-dimensional data matrix.

22. The display device of claim 13, wherein said symbol comprises one of a barcode or a light emitting diode (LED) array.

23. The display device of claim 13, wherein said optical sensor comprises one of a charge coupled device (CCD) or a complementary metal oxide semiconductor (CMOS) laser sensor.

24. The display device of claim 13, wherein said token includes a housing assuming a shape physically associated with a functionality of said application.

25. An interactive display system comprising:
a physical token including a symbol identifying an application; and
an interactive display device including an image projection panel, at least one optical sensor, and a controller having access to said application, said controller being communicatively coupled to said optical sensor and said image projection panel, wherein said controller is configured to initiate said application based on sensing said symbol on said physical token.

26. The interactive display system of claim 25, further comprising a digital light processor configured to project a plurality of pixels onto said display surface.

27. The interactive display device of claim 26, wherein said digital light processor is configured to project a graphical user interface onto said display surface in response to an initiation of said application.

28. The interactive display device of claim 25, wherein said physical token includes a housing assuming a shape physically associated with a functionality of said application.

29. The interactive display device of claim 25, wherein said controller is further configured to select on application from a plurality of applications based on said symbol.

30. The interactive display device of claim 25, wherein said controller is further configured to manipulate said application in response to a sensed movement of said physical token.

31. The interactive display device of claim 25, wherein said symbol comprises one of a two or three-dimensional data matrix, a barcode, or a light emitting diode (LED) array.

32. The interactive display device of claim 25, wherein said physical token further comprises:
an optical receiver configured to receive optical data from said computing device;
a data storage device; and
an external access component.

33. The interactive display device of claim 32, wherein said external access component comprises a transmitter configured to facilitate wireless communication between said physical token and said computing device.

34. A system for initiating an application on a means for computing, comprising:
a token; and
a means for symbolically representing data disposed on said token;
wherein said means for symbolically representing data is configured to cause said means for computing to initiate said application when analyzed by said means for computing

35. The system of claim 34, wherein said token comprises a housing, said housing assuming a physical shape associated with said application.

36. The system of claim 34, wherein said means for symbolically representing data comprises one of a 2 or 3-dimensional data matrix, a barcode, or an array of light emitting diodes (LED).

37. The system of claim 34, wherein said means for symbolically representing data is further configured to initiate a toolset associated with said application.

38. A display system comprising:
a means for projecting an image;
a means for optically sensing an object; and
a means for controlling having access to an application, said means for controlling being communicatively coupled to said means for optically sensing an object and said means for projecting an image, wherein said means for controlling is configured to initiate said application based on sensing a means for symbolically representing data on said object.

39. The display system of claim 38, wherein said means for controlling is further configured to select an application from a plurality of applications based on said means for symbolically representing data.

40. The display system of claim 38, further comprising a digital light processor configured to project a plurality of pixels onto a display surface of said means for projecting an image.

41. The display system of claim 40, wherein said digital light processor is configured to project a graphical user interface onto said display surface in response to an initiation of said application.

42. A method, comprising:
sensing a symbol on a token; and
initiating an application on a computing device based upon sensing the symbol.

43. The method of claim 42, wherein said sensing a symbol on a token is performed by an optical sensor coupled to said computing device.

44. The method of claim 42, further comprising disposing said symbol on said token.

45. The method of claim 42, wherein said optical sensor comprises one of a charge coupled device (CCD) or a complementary metal oxide semiconductor (CMOS) laser sensor.

46. The method of claim 42, further comprising forming said token to physically correspond to said application.

47. The method of claim 42, wherein said symbol comprises one of a 2 or 3-dimensional data matrix, a barcode, or an array of light emitting diodes (LED).

48. The method of claim 41, further comprising communicatively coupling a display surface and a digital light processor to said computing device;
said digital light processor being configured to project a plurality of pixels onto said display surface in response to said application.

49. The method of claim 48, wherein said display surface comprises a rear projection device.

50. The method of claim 41, wherein said physical token further comprises:
an optical receiver configured to receive optical data from said computing device;
a data storage device; and
an external access component.

51. A processor readable medium having instructions thereon for:
scanning a token for a symbol;
decoding said symbol; and
identifying an application associated with said symbol.

52. The processor readable medium of claim 51, further comprising instructions for initiating said identified application.

53. The processor readable medium of claim 51, further comprising instructions for continually monitoring a display surface for recognized movements of said token.

54. The processor readable medium of claim 53, further comprising instructions for accessing a specific toolset of said application in response to a sensed recognized token movement.

55. A computer readable medium having instructions thereon to:
sense a symbol on a token; and
initiate an application on a computing device based upon sensing the symbol.

56. The computer readable medium of claim 55, further comprising instructions for sensing a symbol on a token using an optical sensor coupled to a computing device.

57. The computer readable medium of claim 56, wherein said optical sensor comprises one of a charge coupled device (CCD) or a complementary metal oxide semiconductor (CMOS) laser sensor.

58. The computer readable medium of claim 55, wherein said symbol comprises one of a 2 or 3-dimensional data matrix, a barcode, or an array of light emitting diodes (LED).
